(19) United States
(12) Patent Application Publication
(10) Pub. No.: US 2008/0270100 A1
(43) Pub. Date: Oct. 30, 2008

(54) Method, Apparatus, and Computer Program Product for Implementing Optimized Channel Routing With Generation of FIR Coefficients

(76) Inventors: Benjamin Aaron Fox, Rochester, MN (US); Thomas W. Liang, Rochester, MN (US); Mark Owen Maxson, Mantorville, MN (US); Trevor Joseph Timpane, Rochester, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 11/741,261

(22) Filed: Apr. 27, 2007

(51) Int. Cl. G06G 7/62; G06F 17/10

(52) U.S. Cl. 703/14; 708/300

(57) ABSTRACT

A method, apparatus and computer program product implement optimized channel routing in an electronic package design. Electronic package physical design data are received. A physical design including a netlist including a plurality of nets is generated. Finite impulse response (FIR) driver coefficients are determined for each net in the netlist from simulation with generation of impulse responses of the netlist.

### FIELD OF THE INVENTION

The present invention relates generally to the semiconductor devices, and more particularly to a method, apparatus and computer program product for implementing optimized channel routing with automated generation of finite impulse response (FIR) driver and receiver coefficients for compensation in an electronic package design.

### DESCRIPTION OF THE RELATED ART

In today's physical design environment, printed circuit boards typically are routed based on a set of constraints that are inputted into a design file. These constraints are used to govern the physical layout of the nets based on length, number of vias, available layers, spacing, and the like.

The constraints are usually generated based on simulation results and are used to ensure the wiring constructs of the resulting PCB design are representative of the wiring constructs that were simulated. This requires an electrical to physical translation of the transmission line characteristics. This approach requires considerable up front work to accurately model and simulate the multiple possible physical layout configurations. The performance limiting physical layouts are then translated to physical constraints and are inputted into the physical design constraint management system.

U.S. Pat. No. 6,975,140 to Louis L. Hsu et al, issued Dec. 13, 2005 and assigned to the present assignee, discloses a data transmitter and transmitting method in which an adaptive finite impulse response (FIR) driver has a plurality of taps to which coefficients having updateable values are applied. The FIR driver has a transfer function between an input stream of data bits and an output stream of data bits such that each data bit output from the FIR driver has an amplitude adjusted as a function of the values of a plurality of data bits of the input stream, and the values of the coefficients. The data transmitter includes a rewriteable non-volatile storage, operable to be rewritten with control information representing the values of the coefficients updated during operation of the FIR driver.

A need exists for an effective mechanism for optimized channel routing with automated generation of finite impulse response (FIR) driver coefficients for compensation in an electronic package design.

As used in the following description and claims, the term net means a connection or wire between a number of integrated circuit chips or between transistors in a circuit.

As used in the following description and claims, the term FIR driver coefficients should be understood to include either finite impulse response (FIR) driver coefficients or FIR receiver coefficients, or a combination of FIR driver coefficients and FIR receiver coefficients.

### SUMMARY OF THE INVENTION

Principal aspects of the present invention are to provide a method, apparatus and computer program product for implementing optimized channel routing with automated generation of finite impulse response (FIR) driver coefficients for compensation in an electronic package design. Other important aspects of the present invention are to provide such method, apparatus and computer program product for implementing optimized channel routing in an electronic package design substantially without negative effect and that overcome many of the disadvantages of prior art arrangements.

In brief, a method, apparatus and computer program product are provided for implementing optimized channel routing in an electronic package design. Electronic package physical design data are received. A physical design including a netlist including a plurality of nets is generated. Initial FIR driver coefficients are determined for each net in the netlist from simulation with generation of impulse responses of the netlist.

In accordance with features of the invention, when required performance is not met, the I/O circuit model is updated with compensation based upon updated coefficients. Then re-simulation of the netlist is provided for a re-evaluation of the FIR driver to provide updated coefficients. This adjustment loop can be repeated until required performance criteria are achieved. Identified FIR coefficients are provided for the routed channel nets in the physical design. Additionally the optimal FIR coefficients for a given routed channel net are generated.

In accordance with features of the invention, a table of FIR coefficients is used with a matching signal name for each net in the netlist for identified FIR driver coefficients.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1 and 2 are block diagram representations illustrating a computer system and operating system for implementing optimized channel routing with automated generation of finite impulse response (FIR) driver coefficients for compensation in an electronic package design in accordance with the preferred embodiment;

FIGS. 3 and 4 are respective flow charts illustrating exemplary sequential steps for implementing optimized channel routing with automated generation of finite impulse response (FIR) driver coefficients for compensation in an electronic package design in accordance with the preferred embodiment;

FIG. 5 is a chart illustrating a exemplary method of extracting the first and second FIR driver coefficients for nets of different lengths and configurations in accordance with the preferred embodiment; and

FIG. 6 is a block diagram illustrating a computer program product in accordance with the preferred embodiment.

### DETAILED DESCRIPTION OF THE PREFERRED EMBODIMENTS

In accordance with features of the invention, design system methods are provided for implementing optimized channel routing with automated generation of finite impulse response (FIR) driver coefficients for compensation in an electronic package design. The FIR driver coefficients are identified and are provided with each routed channel net in the physical design. The FIR driver coefficients are chosen for each net in a netlist based upon a simulation after physical design including the netlist. No memory is required for storing FIR driver coefficients, as used in prior art arrangements.

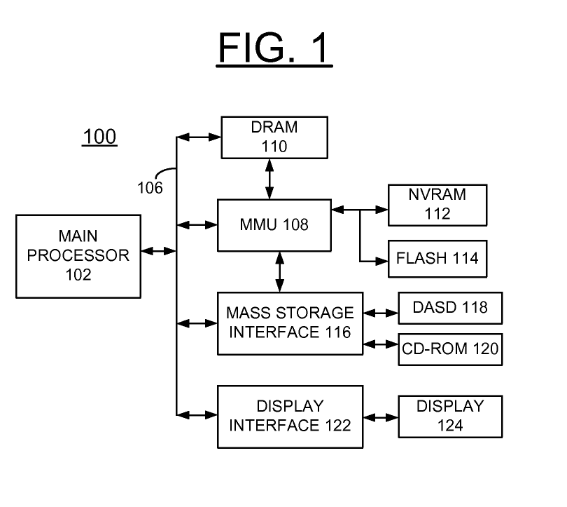

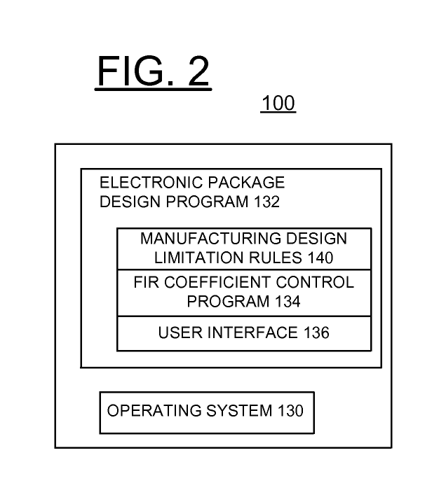

Referring now to the drawings, in FIGS. 1 and 2 there is shown a computer system generally designated by the reference character 100 for implementing methods for optimized channel routing with automated generation of finite impulse response (FIR) driver coefficients for compensation in an electronic package design in accordance with the preferred embodiment. Computer system 100 includes a main processor 102 or central processor unit (CPU) 102 coupled by a system bus 106 to a memory management unit (MMU) 108 and system memory including a dynamic random access memory (DRAM) 110, a nonvolatile random access memory (NVRAM) 112, and a flash memory 114. A mass storage interface 116 coupled to the system bus 106 and MMU 108 connects a direct access storage device (DASD) 118 and a CD-ROM drive 120 to the main processor 102. Computer system 100 includes a display interface 122 coupled to the system bus 106 and connected to a display 124.

Computer system 100 is shown in simplified form sufficient for understanding the present invention. The illustrated computer system 100 is not intended to imply architectural or functional limitations. The present invention can be used with various hardware implementations and systems and various other internal hardware devices, for example, multiple main processors.

As shown in FIG. 2, computer system 100 includes an operating system 130, an electronic package design program 132, a FIR coefficient control program 134 for identifying FIR coefficients of the preferred embodiment, and a user interface 136.

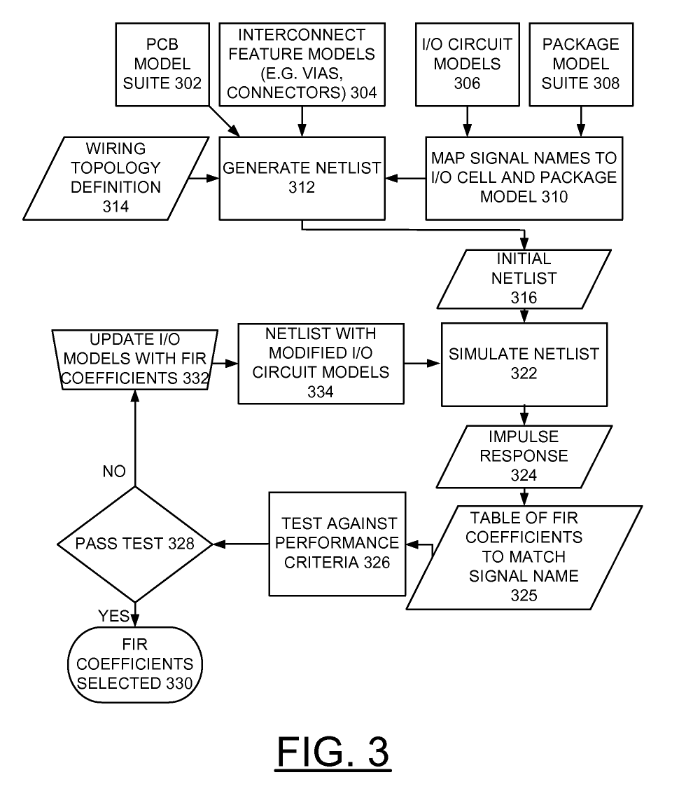

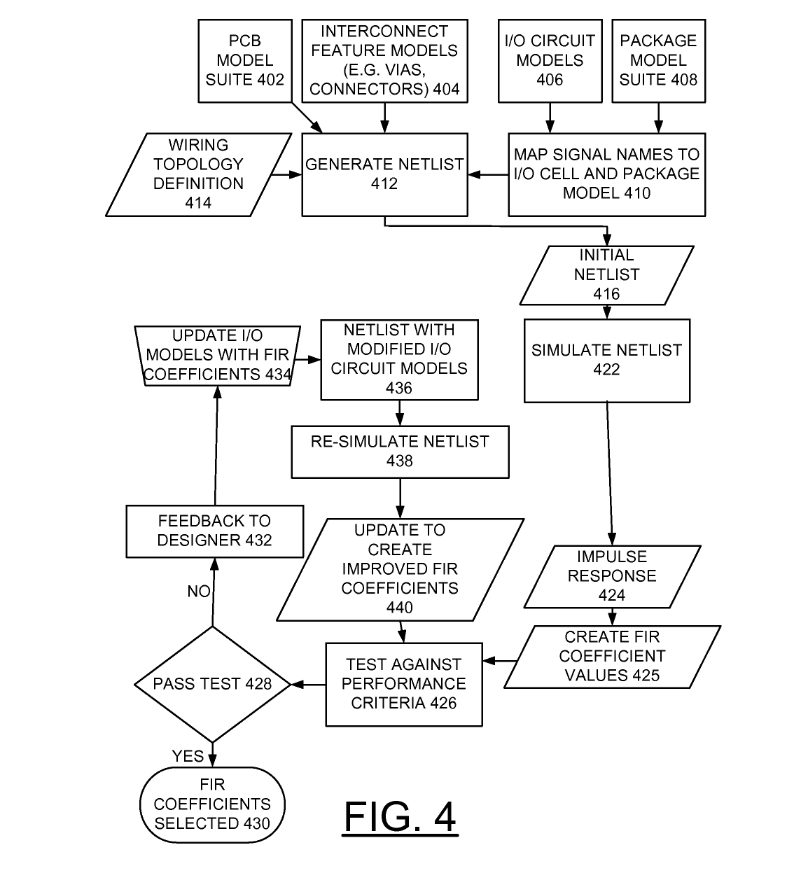

Various commercially available computers can be used for computer system 100, for example, an IBM personal computer. CPU 102 is suitably programmed by the FIR coefficient control program 134 to execute the flowchart of FIGS. 3 and 4 for implementing automated generation of finite impulse response (FIR) driver coefficients for compensation in an electronic package design in accordance with the preferred embodiment.

Referring to FIGS. 3 and 4, there are shown respective flow charts illustrating exemplary sequential steps for implementing optimized channel routing with automated generation of finite impulse response (FIR) driver coefficients for compensation in an electronic package design in accordance with the preferred embodiment.

Referring now to FIG. 3, there are shown exemplary steps performed by the computer system 100 for implementing methods for optimized channel routing with automated generation of finite impulse response (FIR) driver coefficients in accordance with the preferred embodiment.

Electronic and package physical design data and design inputs for an electronic package design are received as indicated a block 302 including a PCB model suite, and a block 304 including interconnect feature models, for example, vias, connectors.

Optionally vendor provided I/O circuit models as indicated at a block 306, and package model suite as indicated at a block 308 are received and applied to a map of signal names to I/O cell and package model as indicated in a block 310.

An analysis tool used to generate a netlist as indicated at a block 312 receives a wiring topology definition as indicated at a block 314 and is coupled to the PCB model suite block 302, interconnect feature models block 304, and the map of signal names to I/O cell and package model block 310.

The appropriate PCB model is selected at block 302 based on the cross-section and line-width used and added to the netlist along with the wire length at block 312. An interconnect feature, such as a via or connector, at block 304 is also added to the netlist at block 312. Also by using the associated signal name at block 310, the mapped I/O cell and package model are also added to the netlist at block 312.

An initial netlist as indicated at a block 316 is provided by the generate netlist tool block 312. The initial netlist at block 316 is created for each net and signal as transmission lines and features are added during board routing. The initial netlist at block 316 includes a circuit description of the signal topology with I/O models.

Simulation of the netlist is performed as indicated at a block 322, with generation of impulse responses of the netlist as indicated at a block 324. A table of FIR coefficients is determined for the simulation output including, for example, FIR coefficient values used in determining effective levels of driver and/or receiver compensation for a certain I/O circuit model and signal net topology as indicated at a block 325. Then the identified FIR coefficients are used in testing against predefined performance criteria as indicated at a block 326. As indicated at a decision block 328, it is determined whether the identified FIR coefficients pass the test. If the selected FIR coefficients pass testing against the predefined performance criteria, then the FIR coefficients are selected as indicated at a block 330.

If the identified FIR coefficients do not pass testing against the predefined performance criteria, then updated circuit I/O models with updated FIR coefficients are provided as indicated at a block 332. A netlist is created with the modified I/O circuit models including the updated FIR coefficients as indicated at a block 334. Then simulation of the new netlist is performed at block 322, analysis of the netlist with generation of impulse responses of the netlist is performed at block 324, and the table of FIR coefficients is determined for the simulation output at block 325. Testing is performed to determine if the required performance criteria is met with the updated FIR coefficients. If so, then the updated FIR coefficients are selected at block 330. Otherwise, the adjustment loop is repeated.

Referring now to FIG. 4, there are shown exemplary steps performed by the computer system 100 for implementing another method for optimized channel routing with automated generation of finite impulse response (FIR) driver coefficients in accordance with the preferred embodiment.

Electronic and package physical design data and design inputs for an electronic package design are received as indicated a block 402 including a PCB model suite, and a block 404 including interconnect feature models, for example, vias, connectors.

Optionally vendor provided or other available I/O circuit models as indicated at a block 406, and package model suite as indicated at a block 408 are received and applied to a map of signal names to I/O cell and package model as indicated in a block 410.

An analysis tool used to generate a netlist as indicated at a block 412 receives a wiring topology definition as indicated at a block 414 and is coupled to the PCB model suite block 402, interconnect feature models block 404, and the map of signal names to I/O cell and package model block 410.

An appropriate PCB model is selected at block 402 based on the cross-section and line-width used and added to the netlist along with the wire length at block 412. An interconnect feature, such as a via or connector, at block 404 is also added to the netlist at block 412. Also by using the associated signal name at block 410, the mapped I/O cell and package model are also added to the netlist at block 412.

An initial netlist as indicated at a block 416 is provided by the generate netlist tool block 412. The initial netlist at block 416 is created for each signal as transmission lines and features that are added during board routing and includes a circuit description of the signal topology. Simulation of the netlist is performed as indicated at a block 422, and analysis with generation of impulse responses of the netlist is performed as indicated at a block 424. Initial FIR coefficient values are created for the simulation output including, for example, FIR coefficient values used in determining effective levels of driver compensation for a certain I/O and topology as indicated at a block 425. Then the identified FIR coefficients are used in testing against predefined performance criteria as indicated at a block 426. As indicated at a decision block 428, it is determined whether the identified FIR coefficients pass the test. If the selected FIR coefficients pass testing against the predefined performance criteria, then the FIR coefficients are selected as indicated at a block 430.

If the identified FIR coefficients do not pass testing against the predefined performance criteria, then feedback optionally is provided to a designer as indicated at a block 432. Next updated I/O models with FIR coefficients are provided, optionally utilizing input from the designer, as indicated at a block 434. A netlist is created with the modified I/O circuit models as indicated at a block 436. Then re-simulation of the new netlist and analysis of the netlist using an impulse response is performed as indicated at a block 438, then updating to create improved FIR coefficients is provided as indicated at a block 440. Testing is performed again to determine if the required performance criteria is met with the updated FIR coefficients at block 426. If so, then the updated FIR coefficients are selected at block 430. Otherwise, the adjustment loop is repeated.

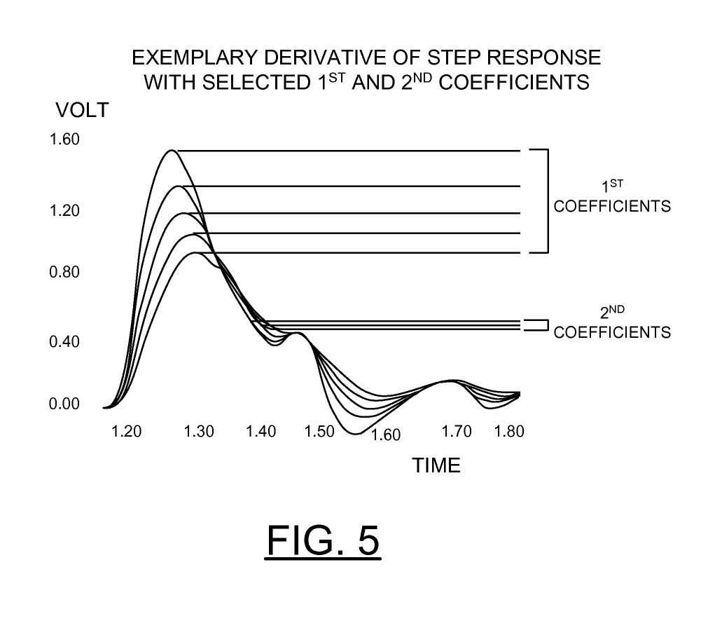

Referring to FIG. 5, there is shown a chart illustrating an exemplary method of extracting the first and second FIR coefficients for nets of different lengths and configurations in accordance with the preferred embodiment.

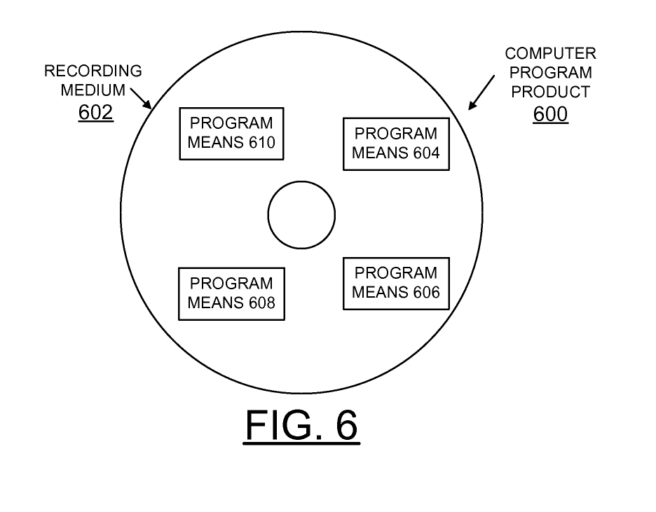

Referring now to FIG. 6, an article of manufacture or a computer program product 600 of the invention is illustrated. The computer program product 600 includes a computer storage medium or recording medium 602, such as, a floppy disk, a high capacity read only memory in the form of an optically read compact disk or CD-ROM, a tape, or another similar computer program product. Recording medium 602 stores program means 604, 606, 608, 610 on the medium 602 for carrying out the methods for implementing optimized channel routing with automated generation of finite impulse response (FIR) driver coefficients for compensation in an electronic package design of the preferred embodiment in the system 100 of FIGS. 1 and 2

A sequence of program instructions or a logical assembly of one or more interrelated modules defined by the recorded program means 604, 606, 608, 610, direct the computer system 100 for implementing optimized channel routing with automated generation of finite impulse response (FIR) driver coefficients of the preferred embodiment.

While the present invention has been described with reference to the details of the embodiments of the invention shown in the drawing, these details are not intended to limit the scope of the invention as claimed in the appended claims.

What is claimed is:

1. A method for implementing optimized channel routing in an electronic package design comprising the steps of:
receiving electronic package physical design data;
generating a physical design including a netlist including a plurality of nets; and
performing a simulation with generation of impulse responses of the netlist to determine FIR driver coefficients for each net in the netlist.

2. A method for implementing optimized channel routing as recited in claim 1 wherein the step of receiving electronic package physical design data includes the steps of receiving signal names, said signal names being mapped to said nets in the netlist.

3. A method for implementing optimized channel routing as recited in claim 1 wherein the step of generating a physical design including a netlist including a plurality of nets includes providing a circuit description of the signal topology with I/O circuit models.

4. A method for implementing optimized channel routing as recited in claim 1 wherein the step of performing a simulation with generation of impulse responses of the netlist to determine FIR driver coefficients for each net in the netlist further includes performing testing with the identified FIR coefficients against predefined performance criteria.

5. A method for implementing optimized channel routing as recited in claim 4 further includes identifying a passing test, and providing the identified FIR coefficients for respective routed channel nets in the physical design for the electronic package design.

6. A method for implementing optimized channel routing as recited in claim 4 further includes identifying a failing test, and providing an updated I/O circuit model with compensation based upon updated FIR coefficients.

7. A method for implementing optimized channel routing as recited in claim 6 further includes repeating simulation of the netlist with generation of impulse responses of the netlist to determine updated FIR coefficients.

8. A method for implementing optimized channel routing as recited in claim 6 further includes repeating an adjustment loop to determine updated FIR coefficients until required performance criteria are achieved.

9. A method for implementing optimized channel routing as recited in claim 1 wherein the step of performing a simulation with generation of impulse responses of the netlist to determine FIR driver coefficients for each net in the netlist includes providing a table of FIR coefficients with matching signal names.

10. A method for implementing optimized channel routing as recited in claim 4 further includes the step of identifying a failing test, and providing feedback to a designer.

11. Apparatus for implementing optimized channel routing with automated generation of finite impulse response (FIR) driver coefficients for compensation in an electronic package design comprising:
an electronic package design program for receiving electronic package physical design data and for generating a physical design including a netlist including a plurality of nets;
a FIR coefficient control program for performing a simulation with generation of impulse responses of the netlist to determine FIR driver coefficients for each net in the netlist.

12. Apparatus for implementing optimized channel routing as recited in claim 11 wherein said FIR coefficient control program performs testing with the identified FIR coefficients against predefined performance criteria.

13. Apparatus for implementing optimized channel routing as recited in claim 12 wherein said FIR coefficient control program identifies a passing test, and provides the identified FIR coefficients for respective routed channel nets in the physical design for the electronic package design.

14. Apparatus for implementing optimized channel routing as recited in claim 12 wherein said FIR coefficient control program identifies a failing test, and provides an updated I/O circuit model with compensation based upon updated FIR coefficients.

15. Apparatus for implementing optimized channel routing as recited in claim 14 wherein said FIR coefficient control program repeats simulation of the netlist with generation of impulse responses of the netlist to determine updated FIR coefficients.

16. Apparatus for implementing optimized channel routing as recited in claim 12 wherein said FIR coefficient control program identifies a failing test, and provides feedback to a designer.

17. A computer storage medium storing a computer program product for implementing optimized channel routing with automated generation of finite impulse response (FIR) driver coefficients for compensation in an electronic package design in a computer system, said computer program product including instructions executed by the computer system to cause the computer system to perform the steps of:
receiving electronic package physical design data;
generating a physical design including a netlist including a plurality of nets; and
performing a simulation with generation of impulse responses of the netlist to determine FIR driver coefficients for each net in the netlist; and
providing the identified FIR coefficients for respective routed channel nets in the physical design for the electronic package design.

18. A computer storage medium storing a computer program product for implementing optimized channel routing as recited in claim 17 wherein the step of performing a simulation with generation of impulse responses of the netlist to determine FIR driver coefficients for each net in the netlist further includes performing testing with the identified FIR coefficients against predefined performance criteria.

19. A computer storage medium storing a computer program product for implementing optimized channel routing as recited in claim 18 further includes identifying a failing test, and providing an updated I/O circuit model with compensation based upon updated FIR coefficients.

20. A computer storage medium storing a computer program product for implementing optimized channel routing as recited in claim 19 further includes repeating simulation of the netlist with generation of impulse responses of the netlist to determine updated FIR coefficients.
